(19) United States
(12) Patent Application Publication
(10) Pub. No.: US 2007/0172556 A1
(43) Pub. Date: Jul. 26, 2007

(54) Multi-compartment container

(75) Inventor: Ashley Francis Berrysmith, Auckland (NZ)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: FRAISBON FOODS LIMITED, Auckland (NZ)

(21) Appl. No.: 11/569,430

(22) PCT Filed: May 20, 2005
(86) PCT No.: PCT/NZ05/00103

§ 371 Date: Nov. 20, 2006

(30) Foreign Application Priority Data
May 20, 2004 (NZ) 533049

(51) Int. Cl. A23B 7/148

(52) U.S. Cl. 426/106

(57) ABSTRACT

A multi compartment food container (5) suitable for housing a salad and a salad dressing comprising a food storage compartment (6) and a food dressing storage compartment (7) wherein said compartments are operatively linked by a communication means (9) adapted to allow mixing of a salad dressing stored in the food dressing compartment with a food stored in the food storage compartment if the container is shaken.

### TECHNICAL FIELD OF THE INVENTION

1. Field of Invention

This invention relates to a multi-compartment food container for housing materials separately. More particularly, but not exclusively the invention relates to a multi-compartment container capable of housing salad and salad dressing separately.

2. Background Art Known to the Applicant

If certain food stuffs for example, a salad is to be provided to consumers in an optimum state it needs to be kept in a substantially airtight container to prevent moisture being lost leaving the salad wilted. In addition, any dressing provided with the salad should only be introduced to the salad just before the salad is consumed to prevent it from becoming soggy.

Accordingly salads are typically sold in a closed container without having the dressing mixed in. In most cases the dressing is contained in a sachet or tub which can be loose within the closed container in which case the consumer has no choice which dressing they will have. Alternatively the sachet or tub will need to be carried separately.

The risk with storing the dressing in the same container is that the dressing can leak through the packaging and into the salad. In some cases the packaging of the dressing can also interfere with or break the closure mechanism of the container allowing moisture to escape.

In addition, prior art containers require the individual packaging of the dressing to firstly be opened and then poured over the salad. This arrangement is messy and requires disposal of the dressing packaging. Mixing normally occurs by stirring the salad with a fork, which is not ideal for producing an even mixture of salad and dressing. Stirring can be very messy and often some of the salad spills out of the container.

Finally, over recent years the growth in “drive through” fast food restaurants has seen a rise in so-called “dashboard dining”—eating whilst at the wheel of a vehicle. Although not recommended, many so-called dashboard dining connoisseurs will attempt to open a sachet of salad dressing with one hand whilst steering a vehicle with the other. There are always going to be individuals prepared to attempt this task in spite of the risk that they pose to other road users, so, accepting this, it may be better to look at the entire current concept of for example, salads and dressings that are currently used in fast food outlets and see whether the packaging of these items cannot be improved.

What is required is a container capable of securely storing the salad and dressing separately to ensure the salad is in an optimum state when it is consumed. In addition a container which also allows the salad and dressing to be easily and thoroughly mixed would be advantageous.

In addition, a container which enables the separate compartments for the salad and dressing to be interchangeable so that consumers or sellers of the salad can match the salad they want with the dressing they want would also be desirable.

### OBJECT

It is an object of the present invention to provide an improved multi-compartment container for housing a food stuff (typically a salad {potato, leaf, waldorf} or chips or meat} and dressing (typically salad dressing, vinegar, mint sauce) separately or at least to provide the public with a useful choice. Although the invention is embodied in several different aspects, it will be apparent from this broad background review that each of these aspects are so linked as to form part of the same general inventive concept.

### STATEMENTS OF THE INVENTION

In one aspect the invention can broadly be said to comprise of a multi compartment food stuff container suitable for housing a salad and a salad dressing comprising:
a food storage compartment; and
a food dressing storage compartment;
   wherein, said compartments are linked by a communication means adapted to allow mixing of a food dressing stored in the food dressing compartment with a food stored in the food storage compartment if the container is shaken.

Such an arrangement should tend to alleviate the problem of premature mixing of the components and will also make mixing of the components easier as only one hand is required.

The multi compartment container could be integrally formed or assembled with a removable lid and/or the food storage compartment could be glued to the food dressing storage compartment. In fact, those skilled in the art will appreciate that there are many different ways of releasably engaging the food storage compartment to the food dressing compartment (e.g. by way of example a threaded screw-on arrangement may be used.

Preferably, the food storage compartment and food dressing storage compartment are provided with complementary engagement means so adapted as to allow both compartments to be releasably engaged with one another to form the multi compartment container.

The communication means could be a nozzle or aperture forming part of a base of the food storage compartment. Similarly, the communication means could be a nozzle or aperture forming part of a top or wall of the food dressing storage compartment. In fact the food storage compartment could have a base with an aperture (or a weakened portion or removable tab that could reveal/form an aperture) and the food dressing compartment could have a top or wall with a nozzle, the latter being able to either insert through the aperture of the base of the food storage compartment or punch its way through the weakened portion.

The base, top or wall either in combination or on their own act as a partition separating the compartments.

Preferably, the communication means comprises a partition (separating the compartments) that incorporates a nozzle or aperture. The aperture in the nozzle can be any diameter and will depend on how viscous the dressing is.

The nozzle may have a removable tear-away cap which would be removed before the food storage and food dressing storage compartments are engaged.

Preferably the container is provided with a lid, the lid and container being provided with complementary engaging means adapted to releasably engage the lid to the container in a substantially fluid tight manner.

The base of the food storage compartment could be integral with and thus substantially rigid with the rest of the compartment. Alternatively, no rigid base could be present and simply a flexible microporous film could span the base of the compartment to provide a floor of sorts.

Preferably the food storage compartment is sealed with a microporous film

Preferably the food dressing storage compartment is substantially concentric with a longitudinal axis of the container and located below the food storage compartment.

The partition could be flat or could be downwardly depending, however, preferably the partition is raised at its centre and the nozzle is located substantially in the centre of the partition.

Preferably the aperture of the nozzle is of a size which also provides some controlled resistance to the flow of a dressing located within the dressing storing compartment.

A labelling system could be used to indicate different types of food dressing compartment. For example different symbols or colours could be used to identify different foods such as salad types and different dressings. The size of the food dressing compartment can vary depending on the nature of the dressing to be contained therein. A dressing could be fluid or fluid like (e.g. a salad dressing) or it could be a solid (e.g. seasoning such as salt).

Preferably, the food storage compartment of the container contains any appropriate selection or combination of food selected from the group comprising meat, salad, chips and a beverage.

Preferably, the food dressing compartment of the container contains any appropriate selection or combination of dressings selected from the group comprising salad, seasoning, vinegar, tartar sauce and vitamins.

The invention includes within its scope a food retail outlet incorporating a container as specified herein.

According to a second aspect of the present invention there is provided a food storage compartment as specified herein, adapted to receive a food dressing storage compartment and a lid also as specified herein.

According to a third aspect of the present invention there is provided a food dressing storage compartment as specified herein for use with a food storage compartment as specified herein.

Although the food dressing storage compartment can be formed from a body which could be then filled with dressing and a lid welded or otherwise fitted to the top of the food dressing storage compartment to complete it, preferably, the food dressing storage compartment is formed as a single piece item from the outset. In this way, the dressing could be fed into the food dressing storage compartment by injection or pumping through an opening in the top of the compartment.

Preferably, the compartment contains a dressing.

### BRIEF DESCRIPTION OF THE DRAWINGS

Preferred embodiments of the present invention will now be more particularly described by way of example only with reference to the accompanying sheets of drawings in which:

FIG. 1 is a schematic isometric view of a container of the present invention.

FIG. 2 is a schematic side view of the container shown in FIG. 1.

### DESCRIPTION OF THE PREFERRED EMBODIMENTS

We refer to the drawings, wherein like numerals designate corresponding parts throughout the two embodiments.

### EXAMPLE 1

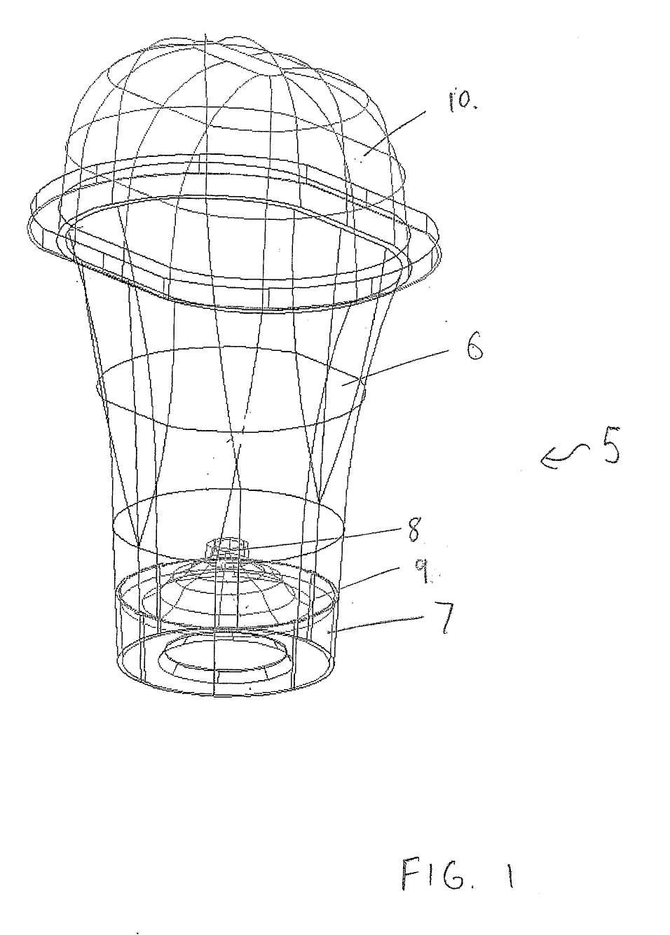

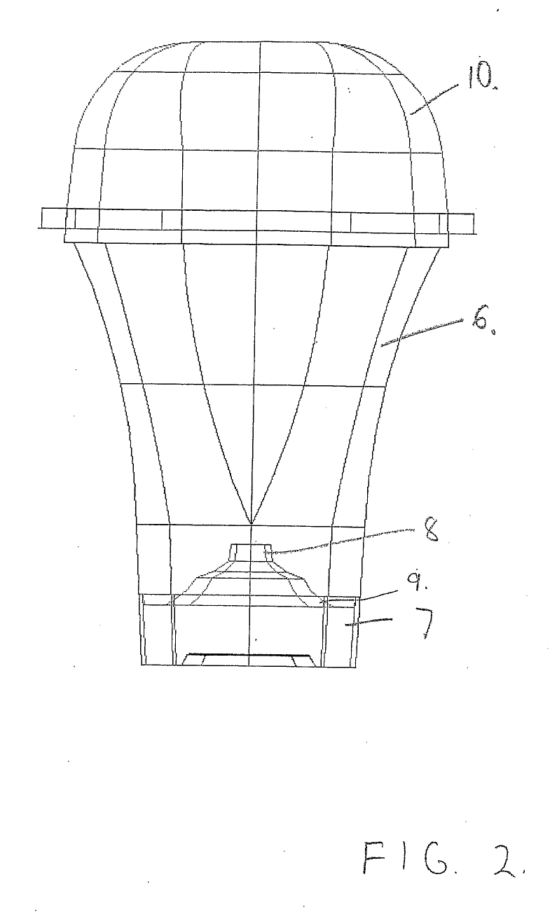

Referring to FIGS. 1 and 2, it can be seen that the elongate columnar clear plastics container generally referenced (5), when assembled, comprises (from top to bottom) a lid (10), a salad storing compartment (6) and a tubular salad dressing storing compartment (7) separated by a partition (9) that forms the top of the salad dressing storing compartment (7). The body of the salad storing compartment (6) flanges outwards towards the top in its normal attitude of operation. The circumferential periphery of the partition (9) is configured to engage with the top of the salad dressing compartment (7) by a snap-on arrangement, which would typically occur after the dressing storing compartment (7) is filled with dressing.

The partition (9) in this example is raised at its centre forming a nozzle (8). The curved nature of the partition is desirable as it assists in collecting and funnelling the dressing into the salad compartment when the container is inverted. The aperture in the nozzle (8) is of a diameter that provides some restriction to the flow of the dressing into the salad compartment (6) in the event that the container (5) is for example, accidentally knocked over on its side. This will minimise any leakage.

The container (5) has a lid (10), which is adapted to be securely fixed to the salad compartment (6) of the container (5).

The dressing compartment (7) with partition (9) is connected to the container (5) by a snap-on arrangement. Once this occurs, salad can be added to the container. When the consumer is ready to consume the salad stored in the container (5), he/she can mix a dressing stored in the container (5) throughout the salad by inverting or shaking the lidded container (5).

Such an action e.g. inversion will cause the dressing to leave the dressing storing compartment (7) by gravity and allow it to be released into the salad storing compartment (6) via the nozzle (8). Shaking the container (5) will assist the flow of the dressing into the salad storing compartment (6) and thoroughly mix the salad and dressing together. The lid (10) will ensure the salad and dressing do not escape from the container (5).

The colour of the salad dressing storing compartment (7) is different to the rest of the container (5) as a visual aid to ensure that the correct dressing is supplied with the salad.

### EXAMPLE 2

In this example (not illustrated) the salad storing compartment (6) includes an integrally formed complementary floor at its base with a circular weakened portion of plastics material that is concentric and a mating fit with the nozzle of the dressing storing compartment (6). This means that the salad can be housed without the need for the dressing compartment (7) to be present (which formed the floor of the salad storing compartment in Example 1).

This means that both the salad and dressing can be housed in their separate compartments (6) & (7) irrespective of whether the salad storing and dressing storing compartments (6) & (7) are engaged with one another.

The floor of the salad storing compartment (6) will be configured to engage with the top and nozzle (8) from the dressing storing component (7). The nozzle (8) has a tear-away cap (not illustrated) which is removed before the salad storing and dressing storing compartments (6) & (7) are connected.

Accordingly as the two compartments (6,7) are engaged, the circular weakened portion is broken by the nozzle (8) as it punctures the portion during the engagement. This would be more hygienic when the dressing compartment (7) is separately stored before sale and would also further minimise any unwanted leakage.

This arrangement is useful particularly if the salad and dressing are likely to be pre packaged in their compartments (6,7) before sale. The consumer could separately choose the salad variety that they wanted and the dressing they wanted. The tearaway cap on the dressing storing compartment (7) could be removed just before the salad is to be consumed. The dressing storing compartment and salad storing compartments (6,7) would then need to be engaged. The lid (10) should also be affixed to the salad storing container (5).

The dressing from the dressing storing compartment (7) can then be released to the salad storing compartment (6) by inverting the container. Gravity will cause the dressing to be released into the salad storing compartment (6) via the nozzle (8). Shaking the container will assist the flow of the dressing through the nozzle into the salad compartment and thoroughly mixes the salad and dressing together.

The present invention allows for a salad and dressing to be separately and safely stored before the salad is consumed. The arrangement with the present invention tends to minimise or prevent the dressing from leaking into the salad. This ensures that the salad remains fresh and will not end up getting soggy due to unwanted leakage of the dressing.

The present invention allows for the dressing to be easily released into the salad by simply inverting the container. By subsequently shaking the container the user ensures that the dressing is evenly and thoroughly distributed throughout the salad. The container of the present invention also allows for the dressing storing compartment to be interchanged easily with the salad storing compartment allowing the user to match the salad they want with the dressing they want giving them more choice.

Throughout the description and claims of this specification the word “comprise” and variations of that word, such as “comprises” and “comprising”, are not intended to exclude other additives, compartments, integers or steps.

In either embodiment, it is most likely the container (5) will be a single use item.

1. A multi compartment food stuff container suitable for housing a salad and a salad dressing comprising:
a food storage compartment; and
a food dressing storage compartment;
wherein, said compartments are operatively linked by a communication means adapted to allow mixing of a food dressing stored in the food dressing compartment with a food stored in the food storage compartment if the container is shaken.

2. A container as claimed in claim 1, wherein the food storage compartment and food dressing storage compartment are provided with complementary engagement means so adapted as to allow both compartments to be releasably engaged with one another to form the multi compartment container.

3. A container as claimed in claim 1 or claim 2, the communication means comprises a partition (separating the compartments) that incorporates a nozzle or aperture.

4. A container as claimed in any preceding claim, wherein the container is provided with a lid, the lid and container being provided with complementary engaging means adapted to releasably engage the lid to the container in a substantially dressing tight manner.

5. A container as claimed in any preceding claim, wherein the food storage compartment is sealed with a microporous film.

6. A container as claimed in any preceding claim, wherein the food dressing storage compartment is substantially concentric with a longitudinal axis of the container and located below the food storage compartment.

7. A container as claimed in any preceding claim, wherein a partition is present that is raised at its centre and the nozzle is located substantially in the centre of the partition.

8. A container as claimed in any preceding claim, wherein the aperture of the nozzle is of a size which also provides some controlled resistance to the flow of a dressing located within the dressing storing compartment.

9. A container as claimed in any preceding claim, wherein the food dressing compartment is distinguishable from other food dressing compartments depending on the nature of the contents to be added thereto.

10. A container as claimed in any preceding claim, wherein the food storage compartment of the container contains any appropriate selection or combination of food selected from the group comprising meat, salad, chips and a beverage.

11. A container as claimed in any preceding claim, wherein the food dressing compartment of the container contains any appropriate selection or combination of dressings selected from the group comprising salad, seasoning, vinegar, tartar sauce and vitamins.

12. A food storage compartment as claimed in claim 1 adapted to receive a food dressing storage compartment and a lid.

13. A food dressing storage compartment as claimed in claim 1 adapted to receive a food storage compartment.

14. A food dressing compartment as claimed in claim 13, wherein the food dressing storage compartment is formed as a single piece item from the outset.

15. A food dressing compartment as claimed in claim 13 or claim 14, wherein the compartment contains a dressing.
